(19) United States
(12) Patent Application Publication
(10) Pub. No.: US 2013/0279045 A1
(43) Pub. Date: Oct. 24, 2013

(54) MAGNETIC HEAD HAVING A CONTACT DETECTION SENSOR

(71) Applicants: Hiroshi Agari, Odawara-shi (JP); Hideaki Tanaka, Odawara-shi (JP); Yoshinori Takeuchi, Ishioka-shi (JP); Koichi Watanabe, Ashigara-kami-gun (JP); Minoru Koike, Odawara-shi (JP); Koji Tanaka, Odawara-shi (JP)

(72) Inventors: Hiroshi Agari, Odawara-shi (JP); Hideaki Tanaka, Odawara-shi (JP); Yoshinori Takeuchi, Ishioka-shi (JP); Koichi Watanabe, Ashigara-kami-gun (JP); Minoru Koike, Odawara-shi (JP); Koji Tanaka, Odawara-shi (JP)

(73) Assignee: Hitachi Global Storage Technologies Netherlands B.V., Amsterdam (NL)

(21) Appl. No.: 13/451,284

(22) Filed: Apr. 19, 2012

(51) Int. Cl. G11B 5/40; G11B 5/127

(52) U.S. Cl. 360/125.3; 360/128; G9B/5.143; G9B/5.04

(57) ABSTRACT

A head for magnetic thermally assisted magnetic data recording, having a read element, a write element a heater element for controlling thermal protrusion of the read and write elements and a thermal sensor for detecting contact a portion of the head with a magnetic media. The thermal contact sensor is arranged so that the thermal conduction between the thermal contact sensor and the read element is substantially equal to the thermal conductivity between the thermal contact sensor and the write element. In this way the accuracy of the detection of thermal contact is maintained whether the read element makes contact with the disk or the write element makes contact with disk.

### FIELD OF THE INVENTION

The present invention relates to magnetic data recording and more particularly to a magnetic head having thermal fly height control and having an optimally positioned contact detection sensor.

### BACKGROUND OF THE INVENTION

The heart of a computer is an assembly that is referred to as a magnetic disk drive. The magnetic disk drive includes a rotating magnetic disk, write and read elements that are suspended by a suspension arm adjacent to a surface of the rotating magnetic disk and an actuator that swings the suspension arm to place the read and write elements over selected circular tracks on the rotating disk. The read and write elements are directly located on a slider that has an air bearing surface (ABS). The suspension arm biases the slider into contact with the surface of the disk when the disk is not rotating, but when the disk rotates, air is swirled by the rotating disk. When the slider rides on the air bearing, the write and read elements are employed for writing magnetic impressions to and reading magnetic impressions from the rotating disk. The read and write elements are connected to processing circuitry that operates according to a computer program to implement the writing and reading functions.

The write element includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic media to return to the return pole of the write element.

A magnetoresistive sensor such as a Giant Magnetoresistive (GMR) sensor, or a Tunnel Junction Magnetoresisive (TMR) sensor can be employed to read a magnetic signal from the magnetic media. The sensor includes a nonmagnetic conductive layer (if the sensor is a GMR sensor) or a thin nonmagnetic, electrically insulating barrier layer (if the sensor is a TMR sensor) sandwiched between first and second ferromagnetic layers, hereinafter referred to as a pinned layer and a free layer. Magnetic shields are positioned above and below the sensor stack and can also serve as first and second electrical leads so that the electrical current travels perpendicularly to the plane of the free layer, spacer layer and pinned layer (current perpendicular to the plane (CPP) mode of operation). The magnetization direction of the pinned layer is pinned perpendicular to the air bearing surface (ABS) and the magnetization direction of the free layer is located parallel to the ABS, but free to rotate in response to external magnetic fields. The magnetization of the pinned layer is typically pinned by exchange coupling with an antiferromagnetic layer.

When the magnetizations of the pinned and free layers are parallel with respect to one another, scattering of the conduction electrons is minimized and when the magnetizations of the pinned and free layer are antiparallel, scattering is maximized. In a read mode the resistance of the spin valve sensor changes about linearly with the magnitudes of the magnetic fields from the rotating disk. When a sense current is conducted through the spin valve sensor, resistance changes cause potential changes that are detected and processed as playback signals.

In order to increase magnetic performance of the read and write elements it is necessary to minimize the magnetic spacing between the head and the media. This requires lowering the fly height as much as possible. One way to reduce and control the magnetic spacing is to use thermally fly height control. In such a system, a heater is placed within the head and is used to heat the head to cause a thermal expansion of the read and write elements. As the heads expand, they extend outward from the air bearing surface thereby reducing the spacing between the read/write elements and the media surface. In order to provide the desired amount of thermal protrusion without contacting the media, a contact sensor is placed within the head. The contact sensor detects a contact between the head and disk as a result of heat generated from the contact.

### SUMMARY OF THE INVENTION

The present invention provides a head for magnetic data recording, that includes a read element; a write element; a thermal contact sensor arranged so as to have a thermal conductivity between the thermal contact sensor and the read element that is substantially equal with a thermal conductivity between the thermal contact sensor and the write element.

The present invention provides a structure wherein a head/disk contact can be sensed with equal efficacy whether the strike occurs at a read element or a write element location of the head. This advantageously provides reliable fly height control at a wide range of operating temperatures.

The structure can include a head for magnetic data recording that includes a read element; a write element; and a thermal contact sensor located substantially equidistant between the read element and the write element. Alternatively, the structure can include a head for magnetic data recording that includes: a read element; a write element; a thermal contact sensor located between the read element and the write element, the thermal contact sensor being located closer to the write element than the read element; and a thermally conductive layer located between the read element and the thermal contact sensor. The structure can also include, a head for magnetic data that includes a read element; a write element; a thermal contact sensor located between the read element and the write element, the thermal contact sensor being located closer to the write element than the read element; and a thermally conductive layer located between the read element and the thermal contact sensor. The structure can also be include, a read element extending to an air bearing surface and formed along a first plane; a write element extending to the air bearing surface and formed along a second plane; and a thermal contact sensor that is located between the first and second planes and that is recessed from the air bearing surface.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an side cross sectional view of a prior art magnetic head;

FIG. 4 is a side cross sectional view of a magnetic head according to an embodiment of the invention;

FIG. 5 is a side cross sectional view of a magnetic head according to another embodiment of the invention;

FIG. 6 is a side cross sectional view of a magnetic head according to yet another embodiment of the invention; and

FIG. 7 is a side cross sectional view of a magnetic head according to still another embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

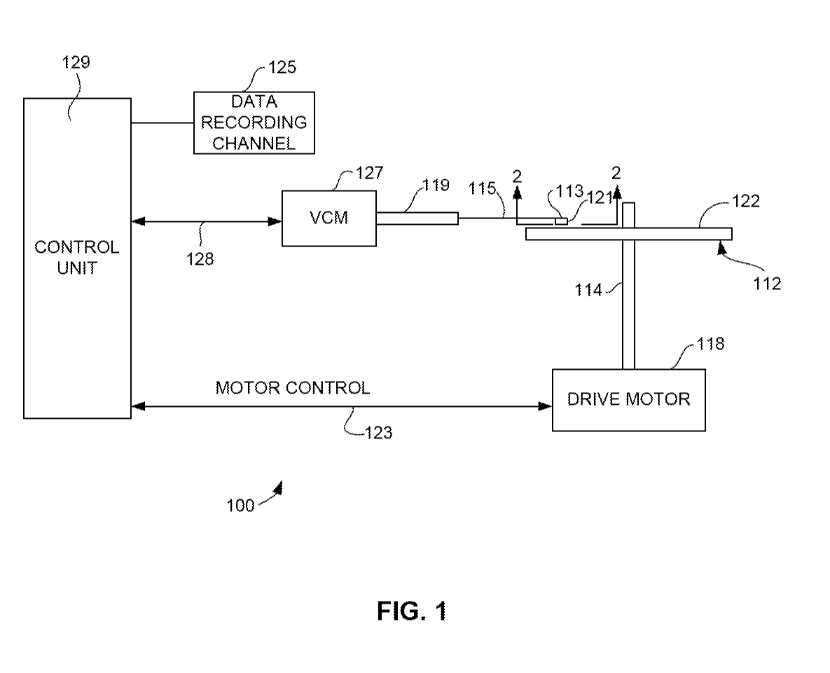

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read elements 121 by way of recording channel 125.

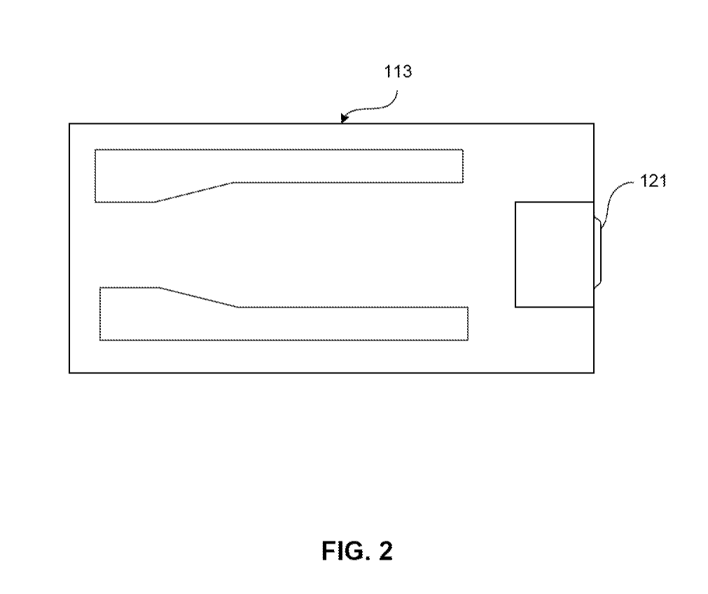

With reference to FIG. 2, the orientation of the magnetic head 121 in a slider 113 can be seen in more detail. FIG. 2 is an ABS view of the slider 113, and as can be seen the magnetic head including an inductive write element and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

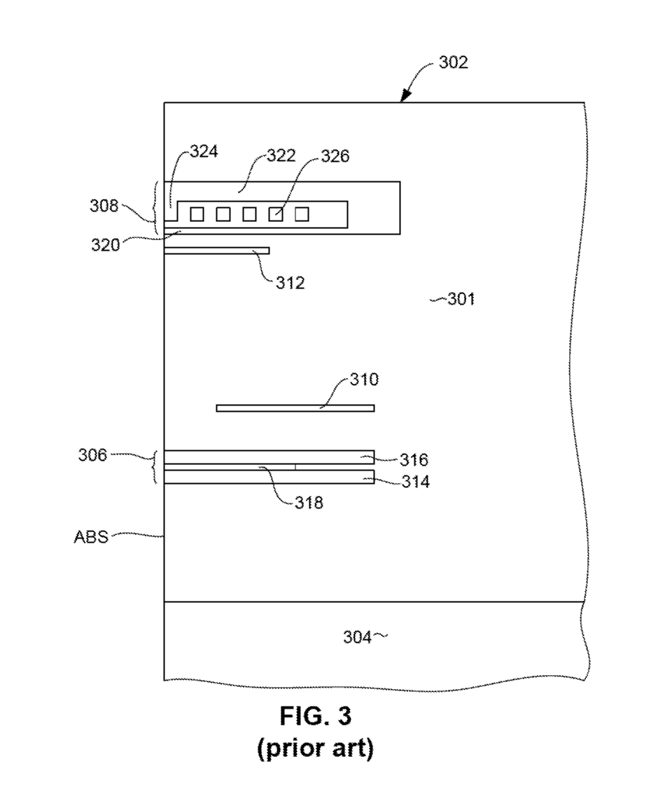

FIG. 3 is a side cross sectional schematic view of a prior art magnetic head 302 formed on a slider body 304 which can be constructed of a ceramic such as TiC or some other suitable material. The head 302 includes a read element 306 and a write element 308. A heater element 310 is provided for thermal fly height control, and a thermal contact sensor 312 is provided for detecting when contact has occurred between a portion of the head 302 and an adjacent magnetic media (not shown in FIG. 3). All of the elements 306, 308, 310, 312 can be embedded within one or more layers of electrically insulating, non-magnetic material such as alumina 301.

The read element 306 can include first and second magnetic shields 314, 316 and a magnetoresistive sensor 318 formed between the shields 314, 316. The write element 308 can include a write pole 320, return pole 322, a trailing magnetic shield 324 and a write coil 326 for inducing a magnetic write field. The write element could also include a leading return pole, which is not shown in FIG. 3.

As discussed above, the performance of the read and write elements 306, 308 increases exponentially with decreasing magnetic spacing between the media (not shown in FIG. 3) and the read and write elements 306,308. Therefore, it can be appreciated that in order to maximize performance it is desirable to make the fly height and magnetic spacing as small as possible. However, it is also very important that the head 302 not actually contact the media, since this can cause permanent damage to the read and write elements 306, 308 as well as the media, resulting in loss of data and system failure.

One way that the magnetic spacing can be controlled it by thermal fly height control. The heating element 310 can be used to heat the components of the head 302. This heating results in a thermal expansion of the read element 306 as well as the write element 308, which causes the read and write elements to protrude outward from the air bearing surface (ABS), thereby reducing the magnetic spacing. To monitor and control such a thermal fly height control system it is necessary detect when contact between any portion of the head 302 and the media has occurred. The contact sensor 312 serves this purpose. When a contact occurs between a portion of the head 302 and the magnetic media, a heat spike is generated as a result of the friction between the head 302 and the media. The sensor 312 is thermally sensitive so that it can detect this temperature change. For example, the thermal sensor 312 can be constructed of a thermo-resistive material having an electrical resistance that changes with temperature. Once contact has been detected, the power to the heating element 310 can be reduced slightly to cause the elements of the head 302 to contact, thereby increasing the magnetic spacing.

Typically, the thermal contact sensor 312 has been located near the write element, far away from the read element 306. Because both the read element 306 and the write element 308 must project toward the magnetic media for optimal performance of each element, previous structural analyses and tests have indicated that placing the heater 310 relatively close to the read element 310 is effective. On the other hand, although the contact sensor must be in between the read element and the write element so that contact by either the read element 306 or write element 308 can be detected, it has been believed that it would be best to place the sensor 312 further from the read element 306 and closer to the write element 308 in order to separate it from the heater element 310, which becomes a source of thermal noise for the sensor 312. Over the past few years, when recording at high frequencies and at higher recording densities, thermal expansion near the write element was believed to be the predominant thermal expansion mode. Because these analyses have been made predominantly at room temperature, this placement of elements 306, 310, 312, 308 was deemed to be best for performance optimization and testing at room temperature validated this belief.

However, in an actual head, the protrusion of the read and write elements 306, 308 resulting from thermal expansion is affected by the ambient temperature in addition to the TFC heater 310, and heat generated by the write element 308. In a high temperature environment the first contact between the head 302 and the medium is in the location of the read element 306 because the read element 306 protrudes further out than the write element as a result of thermal expansion coefficient differences between the elements 306, 308 and the positions of the elements 306, 308 in the head 302. As a result, contact may not be sufficiently detected by the sensor 312 because of the large spacing and poor thermal conductivity between the region of the read element 306 and the sensor 312. After contact of the read element 306, the power to the heater 310 can continue to increase. At other times there may be contact at the location of the write element 308, but the thermal conduction of heat from the previous contact at the location of the read element 306 becomes signal noise for the sensor 312, resulting in inaccurate contact detection and allowing the elements 306, 308 to push into the magnetic media. This results in catastrophic loss of reliability. On the other hand, at a low ambient temperature the first contact can be at the location of the write element 308. In that case a relatively large thermal signal is detected by the sensor 312 due to its close proximity to the write element 308, and contact detection is correct.

In addition to the problems related to variations in ambient temperature, the arrangement shown in FIG. 3 presents a problem with regard to movement of the contact location of the head 302 as a result of fluctuations within the head or within the disk drive system itself.

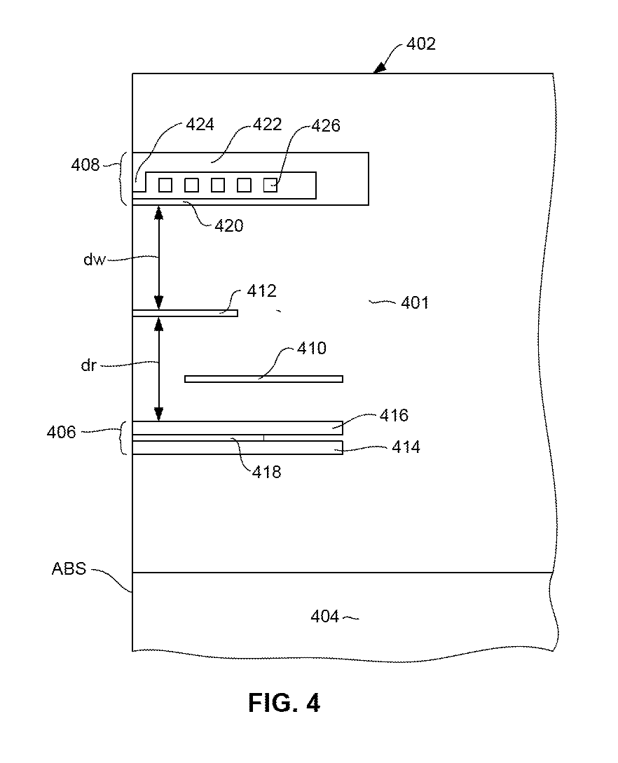

The present invention provides a solution to the above described problems, providing a structure that provides accurate contact detection regardless of ambient temperature variations and regardless of variations or deviations within the head or disk drive system. FIG. 4 shows one possible embodiment of the invention that includes a magnetic head 402 formed on a slider body substrate 404. The head 402 includes a read element 406 and a write element 408. The head 402 also includes a heating element 410 and a thermal contact sensor 412. The read element 406 can include a magnetoresistive sensor 418 that is sandwiched between first and second magnetic shields 414, 416. The write element 408 can include a magnetic write pole 420, a magnetic return pole 422 and may include a trailing magnetic shield 424. The write element 418 also includes a non-magnetic, electrically conductive write coil 426, shown in cross section in FIG. 4, which induces a magnetic write field in the write element 408.

With continues reference to FIG. 4, it can be seen that the thermal contact sensor 412 is located substantially halfway between the read element 406 and the write element 408. The thermal contact sensor 412 is separated from the read element 406 by a distance dr and is separated from the write element by a distance dw, and dr is equal to dw within plus or minus 20% (e.g. dr is 80% to 120% dw). The distance dr can be measured from the center of the thermal contact sensor 412 to the nearest shield 416 as shown in FIG. 4 or could be measured from the center of the thermal contact sensor 412 to the center of the magnetoresistive sensor 418. The distance dw between the thermal contact sensor 412 and the write element 408 can be measured from the center of the thermal contact sensor 412 to the write pole 420, or could be measured from the center of the thermal contact sensor 412 to the trailing shield 424. The thermal heating element 410 is preferably located closer to the read element 406, between the read element 406 and the thermal contact sensor 412. The thermal heating element 410 is also preferably recessed into the head 402, being recessed from the air bearing surface (ABS). All of the elements 406, 408, 410, 412 are embedded within one or more layers of non-magnetic, electrically insulating material such as alumina 401.

By locating the thermal contact sensor 412 equidistant between the read element 406 and the write element 408, the signal detected by the thermal contact sensor 412 will be accurate and reliable regardless of which element (read element 406 or write element 408) makes first contact with the magnetic media. Both the strength of the thermal signal as well as the time required for detection will be the same regardless of whether the read element 406 makes first contact or the write element 408 makes first contact.

In the embodiment shown and described with reference to FIG. 4, it can be seen that the heating element 416 is closer to the thermal contact sensor 412 than was the case in the embodiment described above with reference to FIG. 3. This could lead to thermal noise from the heating element being picked up by the thermal contact sensor 412. This thermal noise from the heater 410 can be reduced, however, by the signal processing of the signal from the thermal contact sensor 412. In addition, thermal noise from the write element 408 and thermal expansion of the write coil 426 can be reduced through the choice of structure and materials in and around the write element. For example, making the coil 426 of a high conductivity material reduces resistive heating of the coil 426 during use.

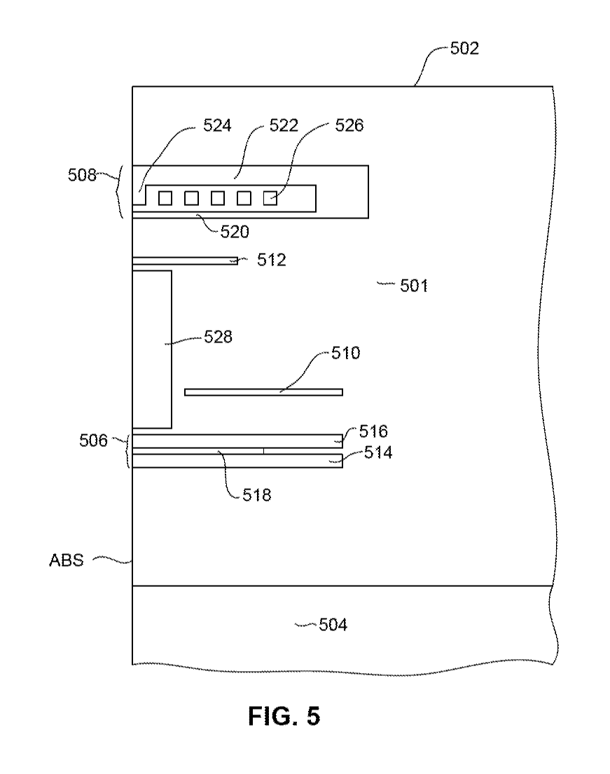

FIG. 5 illustrates another possible embodiment of the invention that can achieve a similar effect as the embodiment described above with reference to FIG. 5 with a different structural arrangement. FIG. 5 shows a magnetic head 502 formed on a slider body substrate 504. The head 502 includes a read element 406, a write element 408, a thermal heater 510 and a thermal contact sensor 512. All of the elements 506, 508, 510, 512 are embedded within one or more layers of electrically insulating, non-magnetic material such as alumina 501.

As before, the read element can include a magnetoresistive sensor 518 sandwiched between first and second magnetic shields 514, 516. The write element can include a magnetic write pole 520 a magnetic return pole 522, a may include a magnetic shield. The write element 408 also includes a write coil 526 for inducing a magnetic write field.

In the present invention, the thermal contact sensor 512 need not be equidistant from each of the read and write elements 506, 508. The thermal contact sensor 512 can be located close to the write element 508 as shown in FIG. 5. The heating element 510 is preferably recessed from the air bearing surface (ABS) and may be located closer to the read element 506 than to the write element 508.

However, in order to ensure that the thermal contact sensor 512 responds equally to a contact at either the read element 506 or the write element 508, a layer of material having a high thermal conductivity 528 is embedded within the head 502 and located between the read element 506 and the thermal contact sensor. The thermally conductive layer structure 528 is preferably constructed of a material having a high thermal conductivity and that also has good film formation, finishing and anticorrosion characteristics such as Ru. If the head 502 is constructed in such a manner that corrosion is not an issue, the thermally conductive layer can be a material such as CNT or graphene. A magnetic head 502 as described with reference to FIG. 5 can achieve the desired effect of maintaining equivalent thermal response to the sensor from either contact at the write element 508 or read element 506 without the need for special signal processing modification to accommodate thermal noise from the write element 508 or for suppressing heat generation from the coil 526.

It should be pointed out as well, that the above described benefit can be achieved for a head having the thermal contact sensor 512 located near the read element 506. For example, the thermal contact sensor 512 could be located near the read element 506 and the high thermal conductivity structure 512 could be located between the thermal contact sensor and the write element 508.

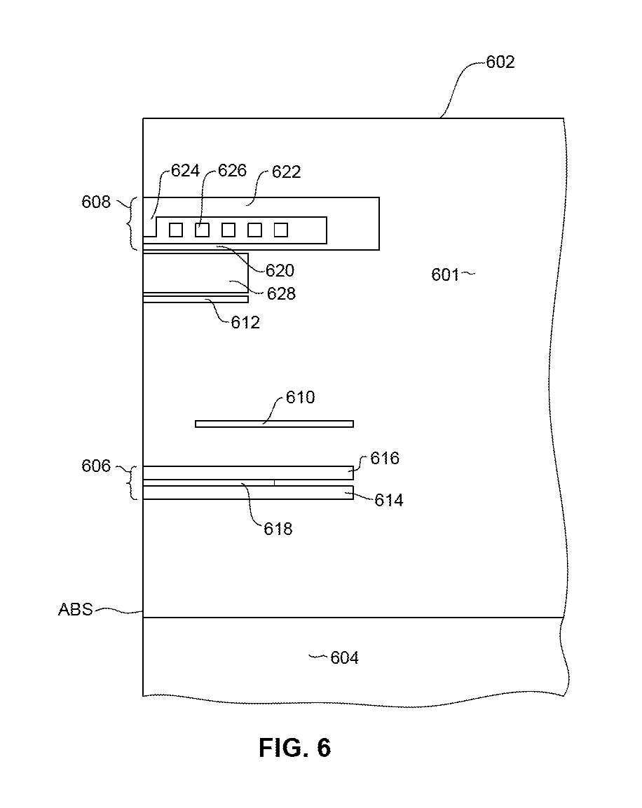

FIG. 6 illustrates a magnetic head 602 according to another possible embodiment of the invention. The magnetic head 602 can be formed on a slider body substrate 604, and can include a read element 606, write element 608 thermal heater 610, and a thermal contact sensor.

The read element can include a magnetoresistive sensor 618 sandwiched between first and second magnetic shields 614, 616. The write element 608 can include a magnetic write pole 620, a magnetic return pole 622 a write coil 626 and may include a trailing magnetic shield 624. The heating element 610 can be embedded within the head, being recessed from the air bearing surface ABS. All of these elements 606, 608, 610, 612 are embedded within one or more layers of electrically insulating, non-magnetic material such as alumina 601.

As with the previous embodiment, the thermal contact sensor 612 need not be equidistant from each of the read element 606 and write element 608. In order to ensure that the thermal contact sensor 612 responds equally to a contact at the read element 606 or at the write element 608, a thermally insulating structure 628 is embedded into the head 602, located between the thermal contact sensor 612 and the element 606, 608 to which it is closest. For example, the thermal contact sensor 612 can be located near the write element and the thermally insulating structure 628 can be located between the thermal contact sensor and the write element 608 as shown in FIG. 6. Alternatively, the thermal contact sensor 612 could be located near the read element 606 and the thermally insulating structure 628 would be located between the thermal contact sensor 612 and the read element 606. The thermal contact sensor is preferably constructed of a material having a lower thermal conductivity than alumina and having good film formation, finishing and anticorrosion characteristics such as NiFe.

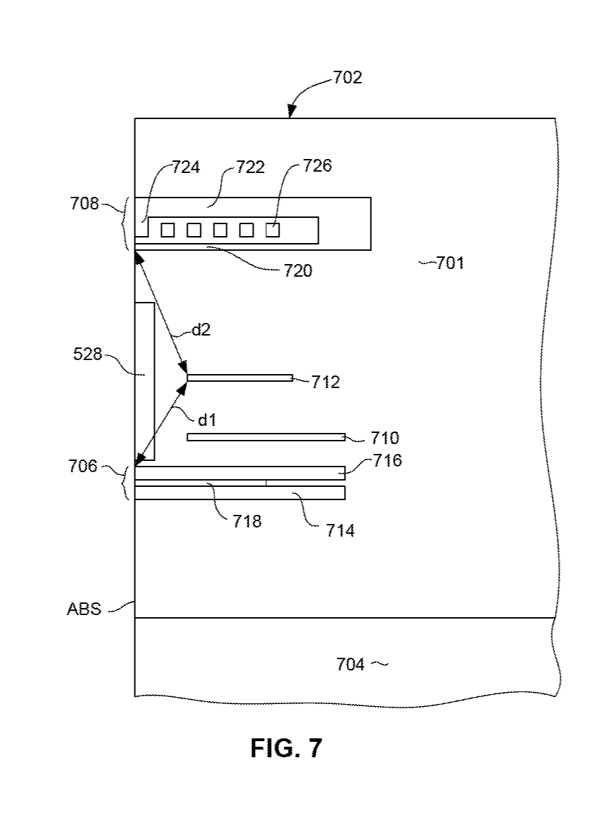

FIG. 7 illustrates still another possible embodiment of the invention. This embodiment of the invention includes a head 702 formed on a slider body substrate 704. The head 702 includes a read element 706 formed along a first plane, a write element 708 formed along a second plane, a heater element 710 and a thermal contact sensor 712. The read element 706 can include a magnetoresistive sensor 718 sandwiched between first and second magnetic shields 716, 718. The write element can include a magnetic write pole 720, magnetic return pole 722, write coil 726 and may include a trailing magnetic shield 724. All of these elements are embedded within one or more layers of electrically insulating, non-magnetic material 701.

The heating element 710 can be located as in the previously described embodiments wherein it is recessed from the ABS and may be near the read element 706. In this embodiment the thermal contact sensor 712 is recessed into the head a significant distance from the air bearing surface (ABS) while being located between the first and second planes. The head 702 can also include a thermally conductive layer 528 located at the ABS such that the heating element 710 and contact sensor 712 are behind the thermally conductive layer 528.

In FIG. 7, the distance d1 is the distance from the thermal contact sensor to the ABS at the location of the read element and the distance d2 is the distance from the thermal contact sensor 712 to the ABS at the location of the write element 708. By placing the thermal contact sensor at a location that is recessed from the ABS, the difference between d1 and d2 is less pronounced even if the thermal contact sensor 712 is not located equidistant from each of the read element 706 and write element 708. This embodiment, therefore, provides additional design freedom with regard to the location of the thermal contact sensor 712 while still ensuring that the thermal contact sensor will respond equally to a head disk contact at either the location of the read element 706 or the write element 708.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A head for magnetic data recording, comprising:
a read element;
a write element; and
a thermal contact sensor located substantially equidistant between the read element and the write element.

2. The head as in claim 1 wherein the thermal contact sensor is located a distance dr from the read element and a distance dw from the write element and wherein dr is between 80% to 120% of dw.

3. The head as in claim 2 wherein the write element has a magnetic write pole and dw is measured from the center of the thermal contact sensor to the write pole.

4. The head as in claim 2 wherein the write element has a trailing magnetic shield and dw is measured from the center of the thermal contact sensor to the trailing magnetic shield.

5. The head as in claim 2 wherein the read element includes a magnetoresistive sensor sandwiched between first and second magnetic shields, and wherein dr is measured from the center of the thermal contact sensor to the center of the magnetoresistive read element.

6. The head as in claim 2 wherein the read element includes a magnetoresistive sensor sandwiched between first and second magnetic shields, and wherein dr is measured from the center of the thermal contact sensor to the nearest of the first and second magnetic shields.

7. The head as in claim 1 further comprising a heater element located between the thermal contact sensor and the read element.

8. A head for magnetic data recording, comprising:
a read element;
a write element;
a thermal contact sensor located between the read element and the write element, the thermal contact sensor being located closer to the write element than the read element; and
a thermally conductive layer located between the read element and the thermal contact sensor.

9. The head as in claim 8 wherein the read element, write element, thermal contact sensor and thermally conductive layer are embedded in alumina and wherein the thermally conductive layer comprises a material having a higher thermal conductivity than alumina.

10. The head as in claim 8 wherein the thermally conductive layer comprises Ru.

11. The head as in claim 8 further comprising a heater element located between the thermal contact sensor and the read element.

12. A head for magnetic data recording, comprising:
a read element;
a write element;
a thermal contact sensor located between the read element and the write element, the thermal contact sensor being located closer to the write element than the read element; and
a thermally insulating layer located between the write element and the thermal contact sensor.

13. The head as in claim 12 wherein the read element, write element, thermal contact sensor and thermally insulating layer are embedded in alumina and wherein the thermally insulating layer comprises a material having a lower thermal conductivity than alumina.

14. The head as in claim 12, wherein the thermally insulating layer comprises NiFe.

15. The head as in claim 12 further comprising a heating element located between the thermal contact sensor and the read element.

16. A head for magnetic data recording, comprising:
a read element extending to an air bearing surface and formed along a first plane;
a write element extending to the air bearing surface and formed along a second plane; and
a thermal contact sensor that is located between the first and second planes and that is recessed from the air bearing surface.

17. A head for magnetic data recording as in claim 16 further comprising a heater element that is located between the first and second planes and that is recessed from the air bearing surface, wherein the thermal contact sensor is recessed from the air bearing surface more than is the heater element.

18. A head for magnetic data recording, comprising:
a read element;
a write element;
a thermal contact sensor arranged so as to have a thermal conductivity between the thermal contact sensor and the read element that is substantially equal with a thermal conductivity between the thermal contact sensor and the write element.

19. The head as in claim 1 wherein the thermal conductivity between the thermal contact sensor and the read element is 80% to 120% of the thermal conductivity between the thermal contact sensor and the write element.

20. The read element as in claim 1 wherein the thermal contact sensor is located between the read element and the write element and further comprising a heater element located between the thermal contact sensor and the read element.
